(19) United States
(12) Patent Application Publication
(10) Pub. No.: US 2007/0153876 A1
(43) Pub. Date: Jul. 5, 2007

(54) Method and apparatus for providing addressing to support multiple access in a wireless communication system

(76) Inventors: Zhouyue Pi, San Diego, CA (US); Mark W. Cheng, San Diego, CA (US)

Correspondence Address: DITTHAVONG & MORI, P.C., Suite A, 10507 Braddock Road, Fairfax, VA, 22032, US

(21) Appl. No.: 11/433,934

(22) Filed: May 15, 2006

Related U.S. Application Data
(60) Provisional application No. 60/755,491, filed on Dec. 30, 2005.

(51) Int. Cl. H04B 1/00

(52) U.S. Cl. 375/140

(57) ABSTRACT

An approach is provided for signaling in multi-carrier system. Communication information that enables communication over a communication network is received. The communication information is mapped to a sequence among a plurality of sequences having a predetermined correlation property to output a communication information sequence.

### RELATED APPLICATIONS

This application claims the benefit of the earlier filing date under 35 U.S.C. §119(e) of U.S. Provisional Application Ser. No. 60/755,491 filed Dec. 30, 2005, entitled “Method and Apparatus for Providing Addressing to Support Multiple Access in a Wireless Communication System,” the entirety of which is incorporated by reference.

### FIELD OF THE INVENTION

Various exemplary embodiments of the invention relate generally to communications.

### BACKGROUND OF THE INVENTION

Radio communication systems, such as cellular systems (e.g., spread spectrum systems (such as Code Division Multiple Access (CDMA) networks), or Time Division Multiple Access (TDMA) networks), provide users with the convenience of mobility along with a rich set of services and features. This convenience has spawned significant adoption by an ever growing number of consumers as an accepted mode of communication for business and personal uses in terms of communicating voice and data (including textual and graphical information). Consequently, cellular service providers are continually challenged to enhance their networks and services. These objectives place a premium on efficient management of network capacity, while accommodating greater numbers of users. Accordingly, one significant area of interest is the signaling and addressing required to support numerous terminals in a wireless system. Current addressing schemes do not scale well.

Therefore, there is a need for an approach to provide an efficient addressing scheme that is suitable for a large number of terminals with minimum overhead.

### SUMMARY OF SOME EXEMPLARY EMBODIMENTS

These and other needs are addressed by the invention, in which an approach is presented for providing a mechanism for conveying communication information (e.g., addressing information) based on sequences with good correlation properties.

According to one aspect of an embodiment of the invention, a method comprises receiving communication information that enables communication over a communication network. The method also comprises mapping the communication information to a sequence among a plurality of sequences having a predetermined correlation property to output a communication information sequence.

According to another aspect of an embodiment of the invention, an apparatus comprises circuitry configured to receive communication information that enables communication over a communication network. The circuitry is further configured to map the communication information to a sequence among a plurality of sequences having a predetermined correlation property to output a communication information sequence.

According to another aspect of an embodiment of the invention, a method comprises receiving, from a base station, communication information that enables communication over a communication network, wherein the communication information is mapped to a sequence among a plurality of sequences having a predetermined correlation property to output a communication information sequence. The method also comprises transmitting a message to the base station using the communication information sequence.

According to yet another aspect of an embodiment of the invention, an apparatus comprises a transceiver configured to receive, from a base station, communication information that enables communication over a communication network. Additionally, the apparatus comprises a processor configured to map the communication information to a sequence among a plurality of sequences having a predetermined correlation property to output a communication information sequence. The transceiver is further configured to transmit a message to the base station using the communication information sequence.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The invention is illustrated by way of example, and not by way of limitation, in the figures of the accompanying drawings in which like reference numerals refer to similar elements and in which:

FIG. 1 is a diagram of the architecture of a wireless system capable of supporting addressing, in accordance with various embodiments of the invention;

FIG. 2 is a flowchart of a mechanism utilized for signaling and addressing, in accordance with various embodiments of the invention;

FIG. 3 is a diagram of a process for supporting a traffic channel transmission, in accordance with an embodiment of the invention;

FIG. 4 is a diagram of exemplary MAC ID sequences, according to an embodiment of the invention;

FIGS. 5A-5C are diagrams of control channel structures utilizing Medium Access Control Index (MAC ID) sequences, in accordance with various embodiments of the invention;

FIG. 6 is a diagram of hardware that can be used to implement various embodiments of the invention;

FIGS. 7A and 7B are diagrams of different cellular mobile phone systems capable of supporting various embodiments of the invention;

FIG. 8 is a diagram of exemplary components of a mobile station capable of operating in the systems of FIGS. 7A and 7B, according to an embodiment of the invention; and

FIG. 9 is a diagram of an enterprise network capable of supporting the processes described herein, according to an embodiment of the invention.

### DESCRIPTION OF THE PREFERRED EMBODIMENT

An apparatus, method, and software for providing a mechanism for use to support signaling and addressing in a communication system are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although the embodiments of the invention are discussed with respect to a spread spectrum system and random or PN (Pseudo random Noise) sequences, it is recognized by one of ordinary skill in the art that the embodiments of the inventions have applicability to any type of communication system (included wired networks) and other sequences.

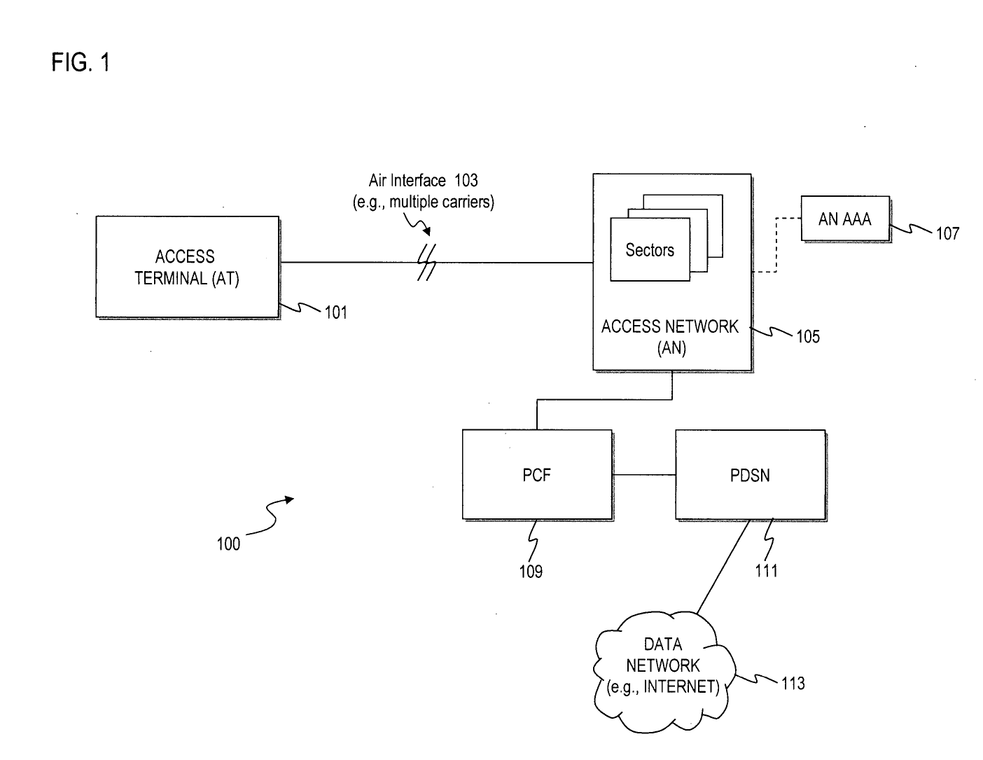

FIG. 1 is a diagram of the architecture of a wireless system capable of supporting signaling and addressing, in accordance with various embodiments of the invention. The radio network 100 includes one or more access terminals (ATs) 101 of which one AT 101 is shown in communication with an access network (AN) 105 over an air interface 103. The system 100, according to one embodiment, provides Third Generation Partnership Project 2 (3GPP2) cdma2000 High Rate Packet Data Revision B (also known as Multi-carrier HRPD, Multi-carrier DO, DO Rev. B, and NXDO) networks. In another embodiment, the invention has applicability to Orthogonal Frequency Division Multiplexing (OFDM) based systems such as cdma2000 High Rate Packet Data Revision C (also known as cdma2000 Evolution Phase 2, DO Rev. C). In cdma2000 systems, e.g., DO Rev. B and DO Rev. C systems, the AT 101 is equivalent to a mobile station, and the access network 105 is equivalent to a base station. The AT 101 is a device that provides data connectivity to a user. For example, the AT 101 can be connected to a computing system, such as a personal computer, a personal digital assistant, and etc. or a data service enabled cellular handset. In DO Rev. B systems, the radio configuration encompasses two modes of operations: 1X and multi-carrier (i.e., nX). Multi-carrier systems employ multiple 1X carriers to increase the data rate to the AT 101 (or mobile station) over the forward link. Hence, unlike 1X technology, the multi-carrier system operates over multiple carriers. In other words, the AT 101 is able to access multiple carriers simultaneously.

In one embodiment, Medium Access Control (MAC) address (or index) is used to indicate the origination or destination of the information transmitted as there are often multiple communication nodes in the system 100. In this example, the MAC index (MAC ID) is assigned to the terminal 101 in the wireless system 100. When there are packets or messages originated from or destined to the AT 101, a specific MAC address is transmitted to identify the source or destination of the packets or messages.

In particular, when transmitting over a forward traffic channel, the AN 105 uses the MAC index to identify the target AT (e.g., AT 101). By way of example, each Walsh channel is identified by a MAC index value and defines a Walsh cover and a unique modulation phase. A more detailed description of the HRPD is provided in 3GPP2 C.S0024-A, entitled “cdma2000 High Rate Packet Data Air Interface Specification,” March 2004, A.S0007-A v2.0, entitled “Interoperability Specification (IOS) for High Rate Packet Data (HRPD) Access Network Interfaces—Rev. A,” May 2003, and 3GPP2 A.S0008-0 v3.0, entitled “Interoperability Specification (IOS) for High Rate Packet Data (HRPD) Access Network Interfaces,” May 2003; which are incorporated herein by reference in their entireties.

The AN 105 is a network equipment that provides data connectivity between a packet switched data network, such as the global Internet 113 and the AT 101. The AN 105 communicates with a Packet Data Service Node (PDSN) 111 via a Packet Control Function (PCF) 109. Either the AN 105 or the PCF 109 provides a SC/MM (Session Control and Mobility Management) function, which among other finctions includes storing of HRPD session related information, performing the terminal authentication procedure to determine whether an AT 101 should be authenticated when the AT 101 is accessing the radio network, and managing the location of the AT 101. The PCF 109 is further described in 3GPP2 A.S0001-A v2.0, entitled “3GPP2 Access Network Interfaces Interoperability Specification,” June 2001, which is incorporated herein by reference in its entirety.

In addition, the AN 105 communicates with an AN-AAA (Authentication, Authorization and Accounting entity) 107, which provides terminal authentication and authorization functions for the AN 105.

Both the cdma2000 1xEV-DV (Evolution—Data and Voice) and 1xEV-DO (Evolution—Data Optimized) air interface standards specify a packet data channel for use in transporting packets of data over the air interface on the forward link and the reverse link. The wireless communication system 100 may be designed to provide various types of services. These services may include point-to-point services, or dedicated services such as voice and packet data, whereby data is transmitted from a transmission source (e.g., a base station) to a specific recipient terminal. Such services may also include point-to-multipoint (i.e., multicast) services, or broadcast services, whereby data is transmitted from a transmission source to a number of recipient terminals (e.g., AT 101).

In the multiple-access wireless communication system 100, communications between users are conducted through one or more AT(s) 101 and a user (access terminal) on one wireless station communicates to a second user on a second wireless station by conveying information signal on a reverse link to a base station. The AN 105 receives the information signal and conveys the information signal on a forward link to the AT station 101. The AN 105 then conveys the information signal on a forward link to the station 101. The forward link refers to transmissions from an AN 105 to a wireless station 101, and the reverse link refers to transmissions from the station 101 to the AN 105. The AN 105 receives the data from the first user on the wireless station on a reverse link, and routes the data through a public switched telephone network (PSTN) to the second user on a landline station. In many communication systems, e.g., IS-95, Wideband CDMA (WCDMA), and IS-2000, the forward link and the reverse link are allocated separate frequencies.

The AN 105, in an exemplary embodiment, includes a High Rate Packet Data (HRPD) base station to support high data rate services. It should be understood that the base station provides the radio frequency (RF) interface (carrier(s)) between an access terminal and the network via one or more transceivers. The HRPD base station provides a separate data only (DO) carrier for HRPD applications for each sector (or cell) served by the HRPD base station. A separate base station or carrier (not shown) provides the voice carrier(s) for voice applications. A HRPD access terminal may be a DO access terminal or a dual mode mobile terminal capable of utilizing both voice services and data services. To engage in a data session, the HRPD access terminal connects to a DO carrier to use the DO high-speed data service. The data session is controlled by a Packet Data Service Node (PDSN) 111, which routes all data packets between the HRPD access terminal and the Internet. The PDSN 111 has a direct connection to the Packet Control Function (PCF) 109, which interfaces with a Base Station Controller (BSC) of the HRPD base station. The BSC is responsible for operation, maintenance and administration of the HRPD base station, speech coding, rate adaptation and handling of the radio resources. It should be understood that the BSC may be a separate node or may be co-located with one or more HRPD base stations.

In a 1x carrier, each HRPD base station can serve multiple (e.g., three) sectors (or cells). However, it should be understood that each HRPD base station may generally serve only a single cell (referred to as an ornni cell). It should also be understood that the network 100 may include multiple HRPD base stations, each serving one or more sectors, with HRPD mobile terminals being capable of handing off between sectors of the same HRPD base station or sectors of different HRPD base stations. For each sector (or cell), the HRPD base station further employs a single shared, time division multiplexed (TDM) forward link, where one single HRPD mobile terminal can be served by single user packets and multiple mobile terminals can be served by multi-user packets at any instance. The forward link throughput rate is shared by all HRPD mobile terminals. A HRPD access terminal selects a serving sector (or cell) of the HRPD base station by pointing its Data Rate Control (DRC) towards the sector and requesting a forward data rate according to the channel conditions (i.e., based on the Carrier to Interference (C/I) ratio of the channel).

Wireless communication technologies continue to evolve to provide higher data rate and better quality of service for a variety of applications with distinct characteristics. The cdma2000 High Rate Packet Data (HRPD) standard provides high data rate over a 1.25 MHz carrier frequency. This system provides Data Only (DO) service in one 1.25 MHz carrier (1x), which sometimes is referred to as 1x DO system. To further improve the service provisioning, this cdma2000 HRPD standard needs to account for multi-carrier CDMA systems. In this system (referred to as multi-carrier HRPD (MC-HRPD) system, or Nx DO system), the access terminal (AT) can transmit and/or receive data streams in multiple 1.25MHz bands.

One approach for accommodating a multitude of ATs in a multi-carrier operation is explained in 3GPP2 contribution, C25-20050620-030, entitled “Increased Forward Link MAC Indices For Multi-Carrier Operation,” Jun. 20, 2005 (which is incorporated herein by reference in its entirety).

In a 1xDO system, each AT 101 is assigned a Medium Access Control Index (MAC ID). The packet transmitted to each AT 101 is identified by the MAC ID; such addressing is necessary so that the ATs 101 (of which only one is shown) will not confuse other users' packets as its own and vice versa. Traditional approaches dictate that up to 64 MAC IDs per 1xDO carrier are available in DO Rev. 0 and up to 128 MAC IDs per 1xDO carrier available in DO Rev. A. With increased capacity in the NxDO system, it is likely that a DO carrier need to support more than 128 ATs, resulting in MAC ID shortage. As mentioned, traditional addressing schemes do not scale well.

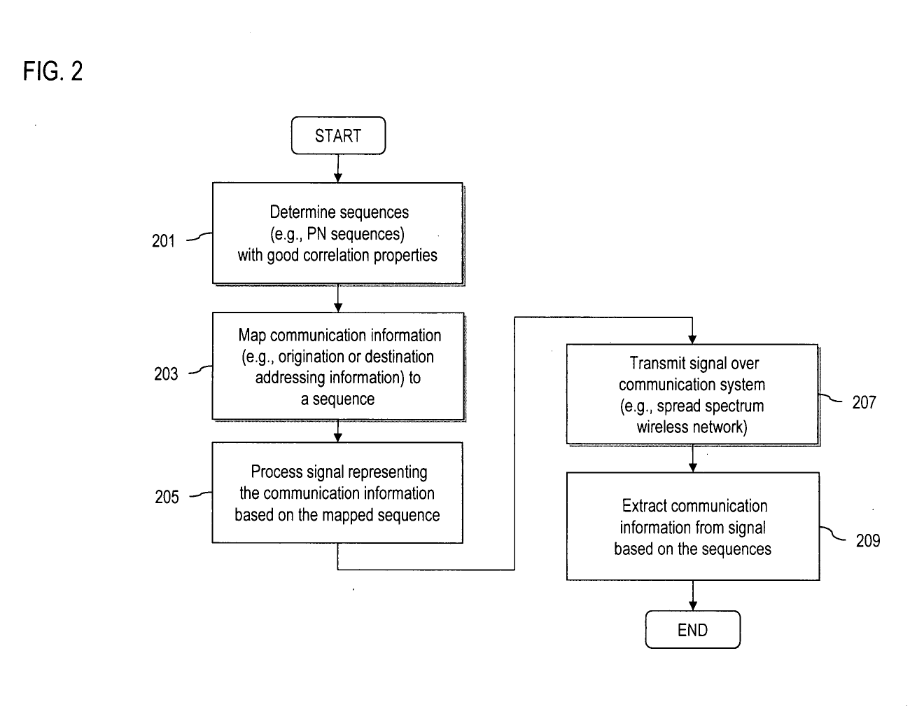

FIG. 2 is a flowchart of a mechanism utilized for addressing, in accordance with various embodiments of the invention. The addressing mechanism, according to one embodiment of the invention, uses sequences with good correlation (e.g., low correlation) properties to indicate communication information (e.g., MAC addresses), as in step 201. One embodiment of the invention uses a long PN (Pseudo Random Noise) sequences.

In step 203, each MAC address is mapped to a sequence (e.g., PN offset). In this manner, a large number of MAC address can be indicated with a given length of PN sequence.

The problem of MAC address shortage can be essentially eliminated, while keeping the overhead low.

By way of example, the following PN sequence generator polynomial is considered:
p(x)=x¹⁵+x¹³+x⁹+x⁸+x⁷+x⁵+1.

This generates a PN sequences with length 2¹⁵-=32767. In order to obtain a zero offset PN sequence, and also to ease system design and implementation, a ‘0’ can be inserted in the sequence after 14 consecutive ‘0’ outputs. The sequence is denoted as b₀b₁ . . . b₃₂₇₆₇. A MAC address can be mapped to a portion of the sequence.

For the purposes of illustration, a 15-bit MAC address is defined. Each 15-bit MAC address is mapped to a 256-bit PN sequence. For example, MAC address 37 is mapped to sequence b₃₇b₃₈ . . . b₂₉₂; and, MAC address 2005 is mapped to sequence b₂₀₀₅b₂₀₀₆ . . . b₂₂₆₀. Further, MAC address 32767 is mapped to sequence b₃₂₇₆₇b₀b₁ . . . b₂₅₄, etc. In this way, 32768 MAC addresses can be supported with 256-bit MAC address. It is noted that if all MAC address sequences are required to be orthogonal, only up to 256 MAC addresses are supported with 256-bit MAC address. Under this approach, 128 times more MAC IDs can be supported than an approach that uses orthogonal MAC ID sequences.

In step 205, the signal representing the communication information is processed based on the mapped sequence—that is, the communication information sequence. Next, the signal is transmitted, as in step 207, over the communication system 100. In step 209, the communication information is extracted from the signal based on the communication information sequence.

It is recognized that for certain mappings, the correlation between two offset positions may be large. Accordingly, further randomization can be employed to change the offset within the PN sequence. As an example, the time of the transmission can be used to change the position of the offset of the PN sequences. A Hash function may be used to determine the offset based on MAC ID and time index. In an exemplary embodiment, the function is as follows:
Offset=(MAC_ID*n+Time_Index*m) mod (PN_Length),

where PN_Length=32768 is the length of the PN sequences.

Another exemplary embodiment can be illustrated in the context of multi-carrier cdma2000 HRPD systems. Under this scenario, a 1x HRPD system can conventionally support up to 128 MAC indices with 64-bit bi-orthogonal sequences. To support more than 128 MAC indices, the signaling mechanism, in one embodiment, utilizes a pseudo-random sequence according to the above PN sequence generator polynomial.

According to one embodiment of the invention, it is contemplated that the AN 105 can still assign bi-orthogonal MAC ID sequence (preamble sequence) first. It is noted that the AN 105 can only support MAC ID less than 128 with this method. When the AN 105 sends a single user packet to the AT 101 with MAC_ID greater than 128, the AN 105 uses a portion of the PN sequence as the MAC ID sequence (preamble sequence) for that AT 101 at that time slot. The offset of the MAC ID sequence can be calculated as follows:
Offset (MAC_ID, Slot_Index)=(MAC_ID*64+Slot_Index) mod 32768.

For example, if the AN 105 transmits a new single user packet to the AT 101 with MAC_ID=156 at slot 25, the offset of the preamble sequence is (156*64+25) mod 32768=10009. The length of the preamble sequence depends on the transmission format. For example, if a packet with transmission format (2048, 2, 128) is transmitted, the preamble length is 128. In this case, the preamble sequence is b₁₀₀₀₉b₁₀₀₁₀. . . b₁₀₁₃₆. Consequently, the AT's assigned orthogonal MAC ID sequences are not particularly impacted because the preamble sequence b₁₀₀₀₉b₁₀₀₀₁₀ . . . b₁₀₁₃₆ resembles random data. Therefore, this slot can treated as a slot without preamble by all other ATs except the targeted AT. In certain embodiments, the length of the MAC ID sequence can be variable—e.g., as a function of time, MAC ID, transmission format, etc. Also, the lengths can vary among different users and at different times.

It is contemplated that the described signaling mechanism can be implemented in a variety of forms. For example, any sequences, in addition to random sequences or pseudo-random sequences, can be utilized in the signaling mechanism. Also, the mapping between the MAC ID and the offset need not be one-to-one. Namely, the mapping can be one-to-one, one-to-many, many-to-one, and many-to-many, or various combinations of these mappings.

Additionally, the mapping between the MAC ID and the offset can change based on time, or altered via a defined protocol/pattern or exchange of signaling messages. The offset can be a function of, for example, MAC ID, time, communication session and connection configurations, type of communication services, and Quality of Service (QoS) parameters.

The signaling approach, although described with respect to addressing, can also be used to indicate other information (e.g., communication information) instead of or in addition to MAC ID. For example, transmission format information such as data rate, encoder packet size, automatic repeat request (ARQ) channel ID, sub-packet ID, or any combination of these information as well as any combination of such information in conjunction with MAC ID.

Further, processing on the mapped sequences can be performed to reduce the correlation. For example, the signaling mechanism can randomly negate one or more MAC ID sequences to enhance randomization.

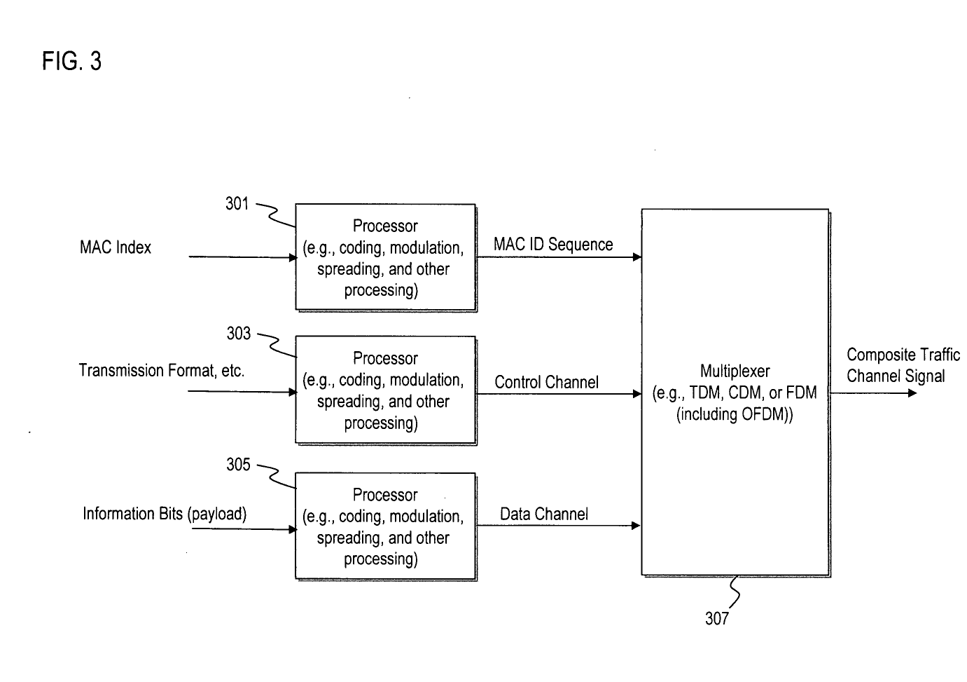

FIG. 3 is a diagram of a process for supporting a traffic channel transmission, in accordance with an embodiment of the invention. The transmission of the communication information can occur in various forms. For the purposes of illustration, the exemplary process is described with respect to the communication information being a MAC address. As seen in FIG. 3, a MAC index is provided as input to a processor 301 to output a MAC ID sequence. In one embodiment, the processor 301 provides coding, modulation, and spreading as well as other communication processing functions. Additionally, the signaling mechanism can involve transmission of a control channel, which contains a MAC address and packet transmission format, along with the packet data channel. The control channel is generated by processor 303 based on such information as transmission format, etc. Moreover, the information bits, including the fixed length MAC address, can be encoded for error protection via processor 305. The length of the MAC address can be selected, for instance, to accommodate the largest possible number of users in the system 100, and yet be as small as possible to minimize overhead.

The outputs of the processors 301, 303 and 305 may be time multiplexed, code multiplexed or frequency multiplexed by multiplexer 307, which generates a composite traffic channel encompassing the MAC ID sequence, the control channel and the data channel. For example, the preamble of the packets exchanged over the system 100 can be viewed as a control channel that contains the coded MAC index information and that is time multiplexed with the data channel.

In general, when a traffic channel transmission occurs, either in the unit of frame, packet, sub-packet, or slot, control information is transmitted along with the data channel that contains the information bits from the upper layer—e.g., payload. As shown in FIG. 3, the MAC ID is transmitted to identify the destination of the transmission; the transmission format information is also transmitted to help the receiver to correctly receive the transmission. The MAC ID information is mapped into a MAC ID sequence after certain processing.

Conventionally, orthogonal or bi-orthogonal sequences are used as MAC ID sequences. For example, in cdma2000 HRPD systems, a 64-bit bi-orthogonal sequence is used to support a 7-bit MAC ID. It is recognized that when a large number of users are operating in the system, the conventional approach of using orthogonal or bi-orthogonal sequences are inadequate. For example, if a 15-bit MAC ID is needed, a 4096-bit bi-orthogonal sequence would be used; this entails a large overhead.

By contrast, the approach of the invention, according to various embodiments, employs sequences that exhibit good correlation property as communication information (e.g., MAC ID) sequences. It is contemplated that this mechanism can be utilized to specify other information instead of or in addition to MAC ID; such information (e.g., “communication information”) can be any type of information or parameter that enables communication over a communication network. Also, the sequences need not be orthogonal to each other, but only that their correlation is sufficiently small as to negligibly affect system performance. The determination of what is an acceptable level of performance degradation depends, in part, on the particular applications and services the system 100 is providing. Thus, this approach advantageously accommodates a large number of users with minimal overhead, and nominal performance degradation.

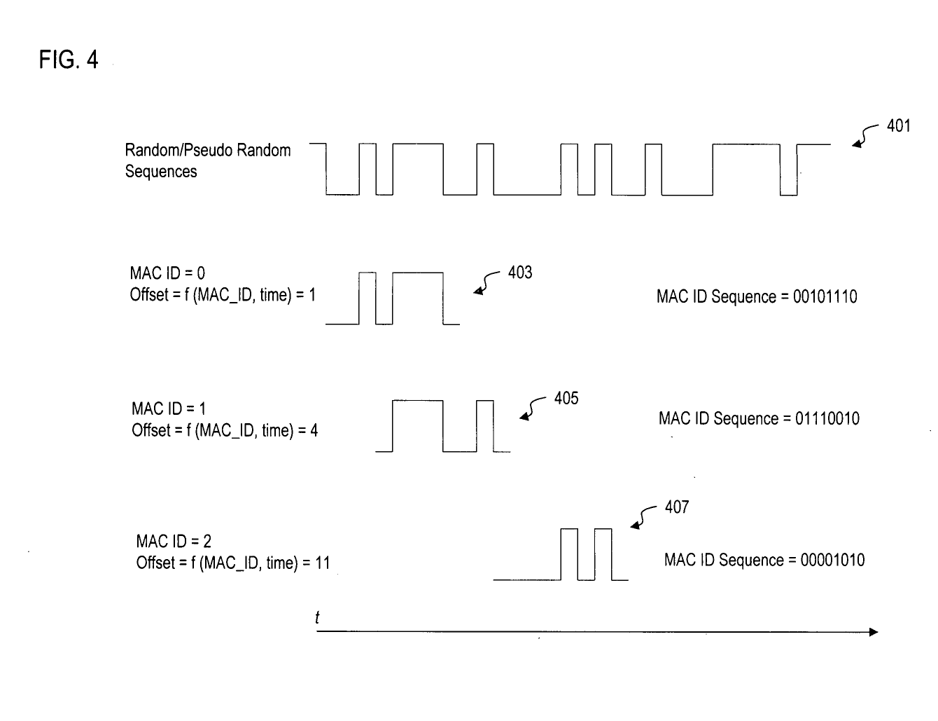

FIG. 4 is a diagram of exemplary MAC ID sequences, according to an embodiment of the invention. Waveform 401 represents random/pseudo-random sequences. However, it is recognized that any other sequences, instead of random sequences or pseudo-random sequences, can be utilized. From the sequences, MAC ID sequences are generated. In this example, waveform 403 corresponds to MAC ID of 0, with an offset time of 1. This waveform 403 is used to represent a MAC ID sequence of 00101110, for instance. Waveform 405 represents MAC ID of 1, in which the offset time is 4. The waveform 405 corresponds to a MAC ID sequence of 01110010. Likewise, MAC ID of 2 (without offset of 11) can be represented by waveform 407, which specifies a MAC ID sequence of 00001010.

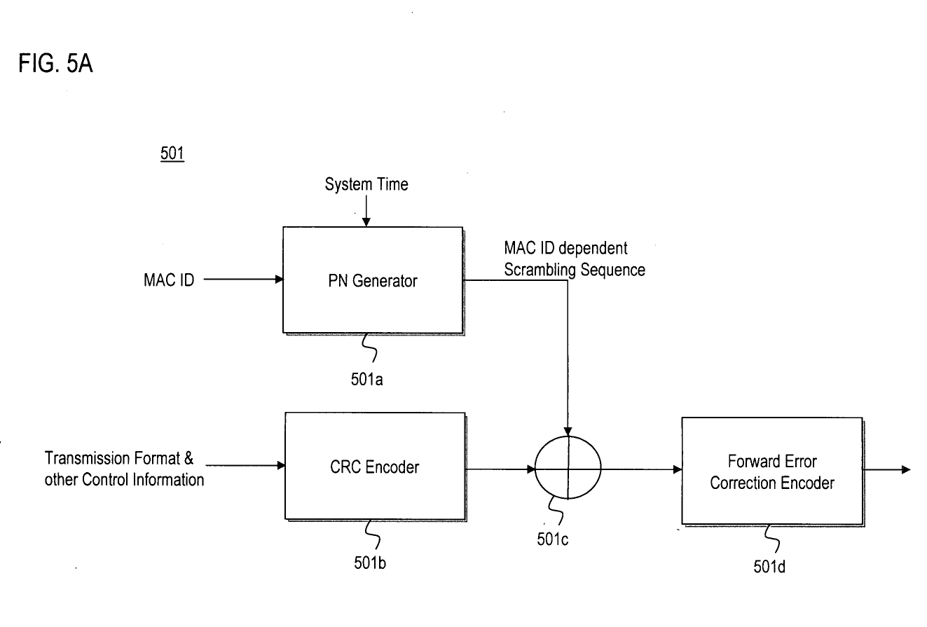

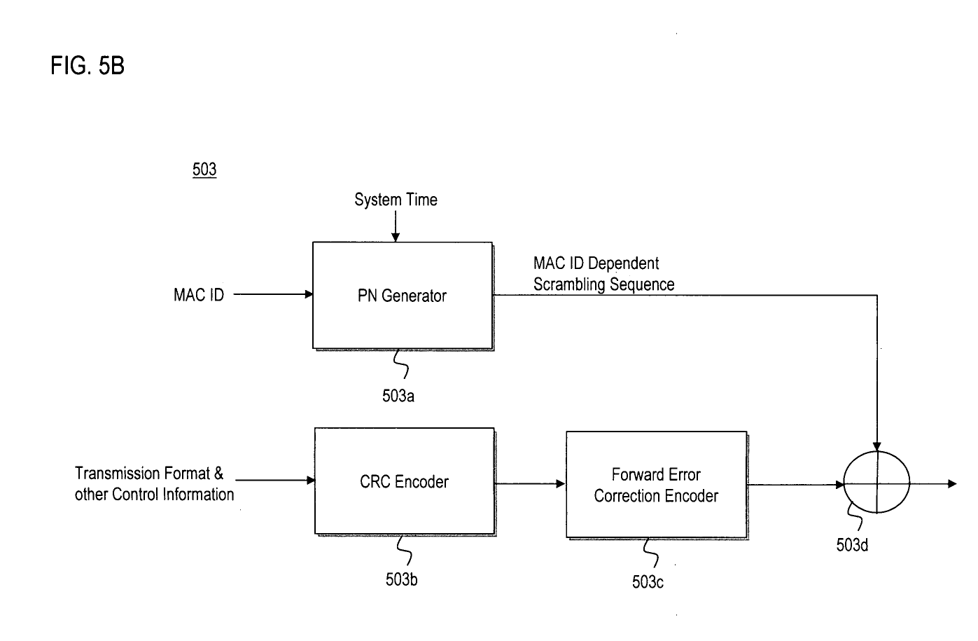

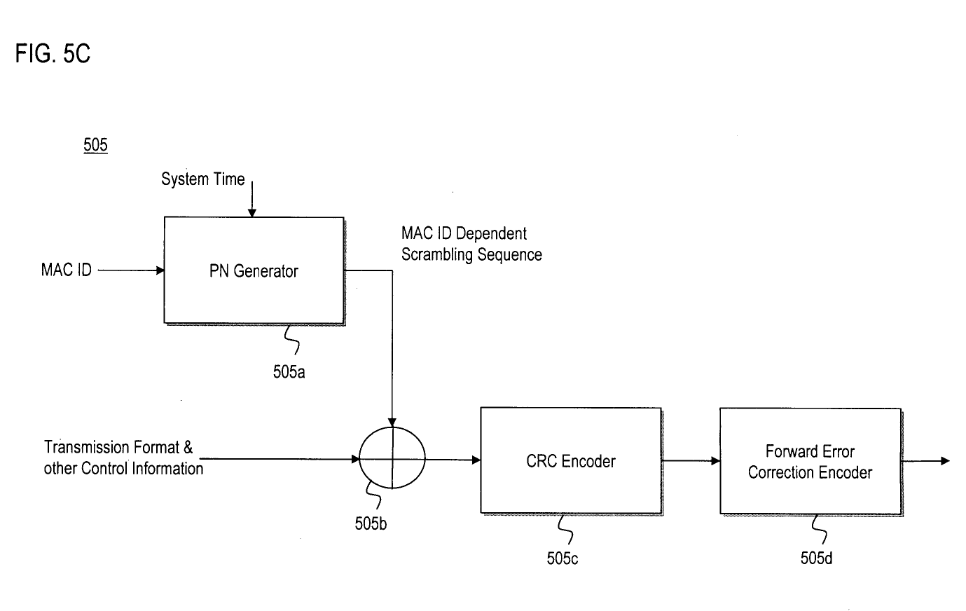

The communication information (e.g., MAC ID) sequences can be utilized for other purposes as well, as explained in FIGS. 5A-5C.

FIGS. 5A-5C are diagrams of control channel structures utilizing Medium Access Control Index (MAC ID) sequences, in accordance with various embodiments of the invention. After a MAC ID is mapped into a sequence, there are different ways of using this sequence. One exemplary embodiment is to use this sequence to scramble the code symbols of other control information, as shown FIG. 5A. Other embodiments are also contemplated. For example, the MAC ID sequence can be used to scramble a Forward Error Correction (FEC) encoded symbols of other control information (FIG. 5B). Alternatively, the MAC ID sequence can be utilized to scramble other control information bits in raw (i.e., non-encoded, unprocessed, etc.) form (FIG. 5C).

Per FIG. 5A, circuitry 501 includes a PN generator 501a that outputs a MAC ID sequence in response to a MAC ID. This MAC ID sequence is employed as a scrambling sequence. Under this scenario, a cyclic redundancy check (CRC) encoder 501b can encode information such as transmission format as well as other control information. The output is scrambled with the MAC ID sequence at adder 501c. The resultant output is then fed to a forward error correction (FEC) encoder 501d.

In the embodiment of FIG. 5B, circuitry 503 utilizes the MAC ID sequence from the PN generator 503a to scramble the signal output from a FEC encoder 503b. The output is based on a CRC coded signal from a CRC encoder 503c. The CRC encoder 503c, as with the example of FIG. 5A, can employ various control information as input to the CRC encoder 503c. The adder 503d produces a scrambled signal based on the MAC ID sequence applied to the signal from the FEC encoder 503b.

Further, under the scenario of FIG. 5C, a PN generator 505a produces the MAC ID sequence, which is used to scramble the raw (i.e., unencoded) control information at adder 505b. The resultant signal is then encoded by CRC encoder 505c and FEC encoder 505d.

In certain embodiments, the described signaling mechanism utilizes pseudo-random sequences or other sequences (with good correlation properties) to support addressing of multiple ATs. Advantageously, this mechanism can support greater numbers of ATs than the conventional approach that requires the MAC ID sequences to be orthogonal.

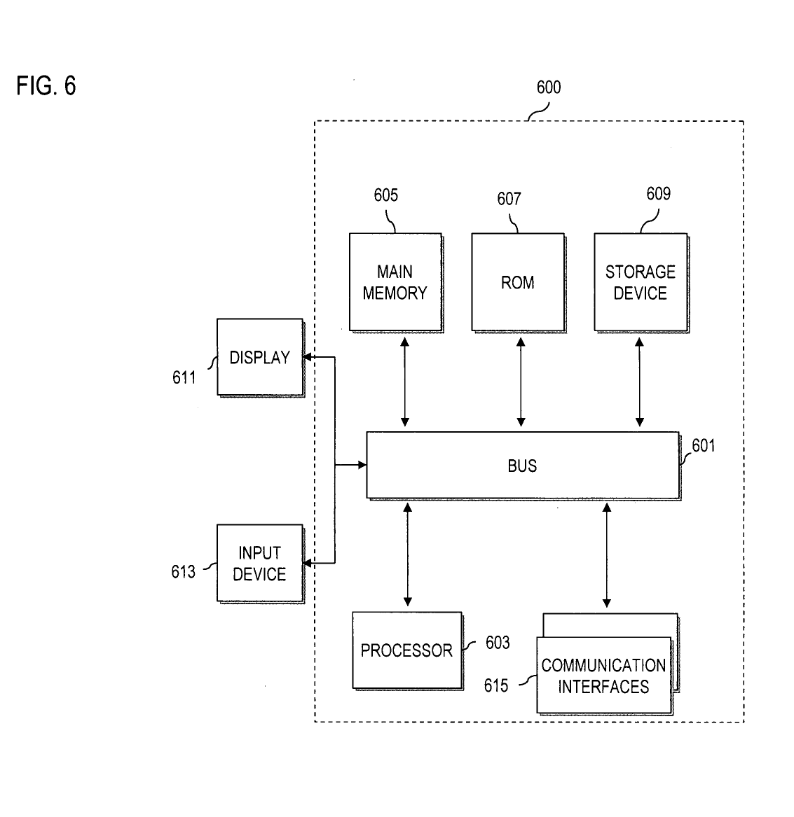

One of ordinary skill in the art would recognize that the processes for providing address signaling may be implemented via software, hardware (e.g., general processor, Digital Signal Processing (DSP) chip, an Application Specific Integrated Circuit (ASIC), Field Programmable Gate Arrays (FPGAs), etc.), firmware, or a combination thereof. Such exemplary hardware for performing the described functions is detailed below with respect to FIG. 6.

FIG. 6 illustrates exemplary hardware upon which various embodiments of the invention can be implemented. A computing system 600 includes a bus 601 or other communication mechanism for communicating information and a processor 603 coupled to the bus 601 for processing information. The computing system 600 also includes main memory 605, such as a random access memory (RAM) or other dynamic storage device, coupled to the bus 601 for storing information and instructions to be executed by the processor 603. Main memory 605 can also be used for storing temporary variables or other intermediate information during execution of instructions by the processor 603. The computing system 600 may further include a read only memory (ROM) 607 or other static storage device coupled to the bus 601 for storing static information and instructions for the processor 603. A storage device 609, such as a magnetic disk or optical disk, is coupled to the bus 601 for persistently storing information and instructions.

The computing system 600 may be coupled via the bus 601 to a display 611, such as a liquid crystal display, or active matrix display, for displaying information to a user. An input device 613, such as a keyboard including alphanumeric and other keys, may be coupled to the bus 601 for communicating information and command selections to the processor 603. The input device 613 can include a cursor control, such as a mouse, a trackball, or cursor direction keys, for communicating direction information and command selections to the processor 603 and for controlling cursor movement on the display 611.

According to various embodiments of the invention, the processes described herein can be provided by the computing system 600 in response to the processor 603 executing an arrangement of instructions contained in main memory 605. Such instructions can be read into main memory 605 from another computer-readable medium, such as the storage device 609. Execution of the arrangement of instructions contained in main memory 605 causes the processor 603 to perform the process steps described herein. One or more processors in a multi-processing arrangement may also be employed to execute the instructions contained in main memory 605. In alternative embodiments, hard-wired circuitry may be used in place of or in combination with software instructions to implement the embodiment of the invention. In another example, reconfigurable hardware such as Field Programmable Gate Arrays (FPGAs) can be used, in which the finctionality and connection topology of its logic gates are customizable at run-time, typically by programming memory look up tables. Thus, embodiments of the invention are not limited to any specific combination of hardware circuitry and software.

The computing system 600 also includes at least one communication interface 615 coupled to bus 601. The communication interface 615 provides a two-way data communication coupling to a network link (not shown). The communication interface 615 sends and receives electrical, electromagnetic, or optical signals that carry digital data streams representing various types of information. Further, the communication interface 615 can include peripheral interface devices, such as a Universal Serial Bus (USB) interface, a PCMCIA (Personal Computer Memory Card International Association) interface, etc.

The processor 603 may execute the transmitted code while being received and/or store the code in the storage device 609, or other non-volatile storage for later execution. In this manner, the computing system 600 may obtain application code in the form of a carrier wave.

The term “computer-readable medium” as used herein refers to any medium that participates in providing instructions to the processor 603 for execution. Such a medium may take many forms, including but not limited to non-volatile media, volatile media, and transmission media. Non-volatile media include, for example, optical or magnetic disks, such as the storage device 609. Volatile media include dynamic memory, such as main memory 605. Transmission media include coaxial cables, copper wire and fiber optics, including the wires that comprise the bus 601. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the invention may initially be borne on a magnetic disk of a remote computer. In such a scenario, the remote computer loads the instructions into main memory and sends the instructions over a telephone line using a modem. A modem of a local system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

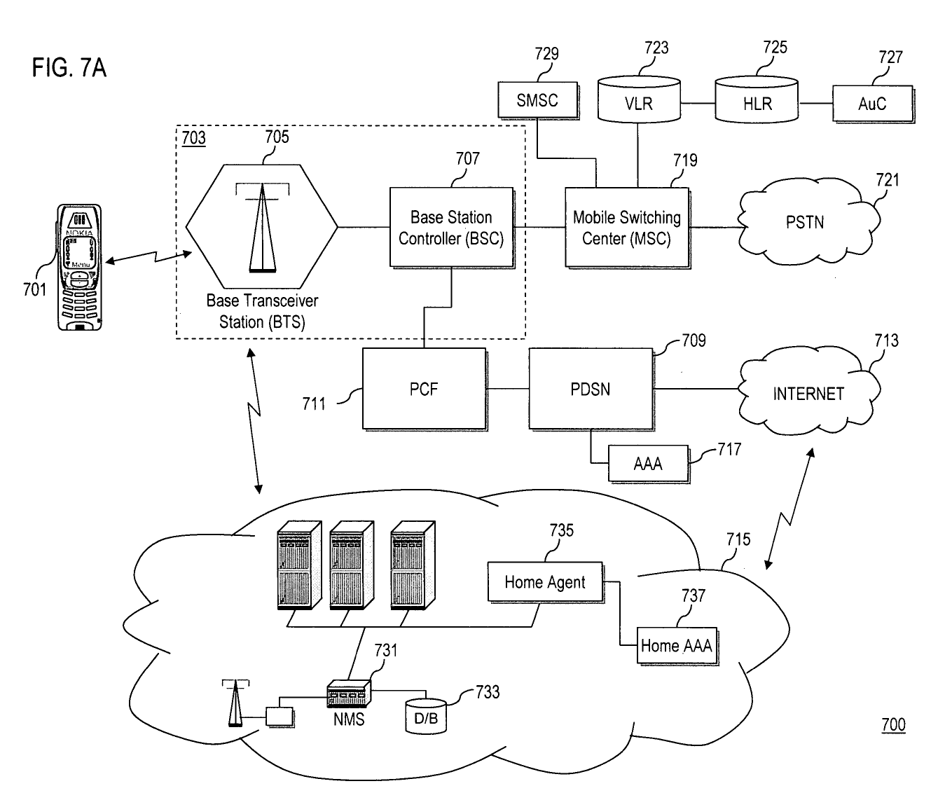

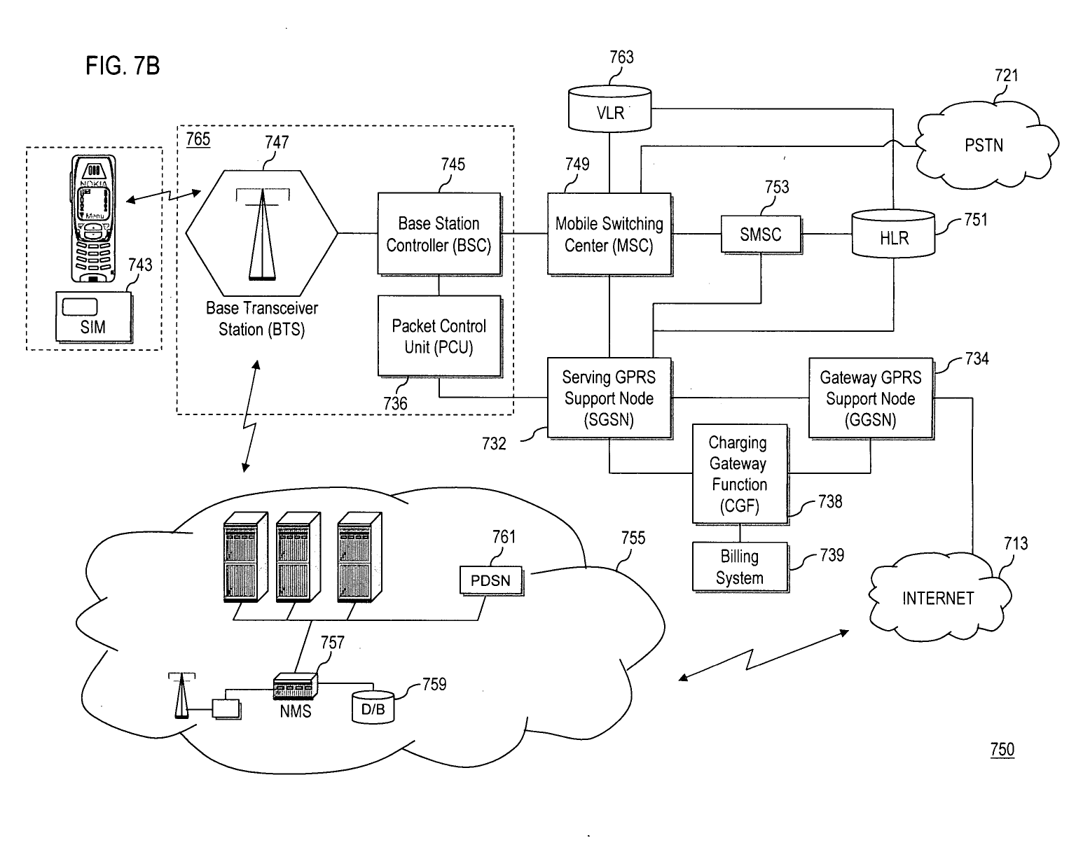

FIGS. 7A and 7B are diagrams of different cellular mobile phone systems capable of supporting various embodiments of the invention. FIGS. 7A and 7B show exemplary cellular mobile phone systems each with both mobile station (e.g., handset) and base station having a transceiver installed (as part of a Digital Signal Processor (DSP)), hardware, software, an integrated circuit, and/or a semiconductor device in the base station and mobile station). By way of example, the radio network supports Second and Third Generation (2G and 3G) services as defined by the International Telecommunications Union (ITU) for International Mobile Telecommunications 2000 (IMT-2000). For the purposes of explanation, the carrier and channel selection capability of the radio network is explained with respect to a cdma2000 architecture. As the third-generation version of IS-95, cdma2000 is being standardized in the Third Generation Partnership Project 2 (3GPP2).

A radio network 700 includes mobile stations 701 (e.g., handsets, terminals, stations, units, devices, or any type of interface to the user (such as “wearable” circuitry, etc.)) in communication with a Base Station Subsystem (BSS) 703. According to one embodiment of the invention, the radio network supports Third Generation (3G) services as defined by the International Telecommunications Union (ITU) for International Mobile Telecommunications 2000 (IMT-2000).

In this example, the BSS 703 includes a Base Transceiver Station (BTS) 705 and Base Station Controller (BSC) 707. Although a single BTS is shown, it is recognized that multiple BTSs are typically connected to the BSC through, for example, point-to-point links. Each BSS 703 is linked to a Packet Data Serving Node (PDSN) 709 through a transmission control entity, or a Packet Control Function (PCF) 711. Since the PDSN 709 serves as a gateway to external networks, e.g., the Internet 713 or other private consumer networks 715, the PDSN 709 can include an Access, Authorization and Accounting system (AAA) 717 to securely determine the identity and privileges of a user and to track each user's activities. The network 715 comprises a Network Management System (NMS) 731 linked to one or more databases 733 that are accessed through a Home Agent (HA) 735 secured by a Home AAA 737.

Although a single BSS 703 is shown, it is recognized that multiple BSSs 703 are typically connected to a Mobile Switching Center (MSC) 719. The MSC 719 provides connectivity to a circuit-switched telephone network, such as the Public Switched Telephone Network (PSTN) 721. Similarly, it is also recognized that the MSC 719 may be connected to other MSCs 719 on the same network 700 and/or to other radio networks. The MSC 719 is generally collocated with a Visitor Location Register (VLR) 723 database that holds temporary information about active subscribers to that MSC 719. The data within the VLR 723 database is to a large extent a copy of the Home Location Register (HLR) 725 database, which stores detailed subscriber service subscription information. In some implementations, the HLR 725 and VLR 723 are the same physical database; however, the HLR 725 can be located at a remote location accessed through, for example, a Signaling System Number 7 (SS7) network. An Authentication Center (AuC) 727 containing subscriber-specific authentication data, such as a secret authentication key, is associated with the HLR 725 for authenticating users. Furthermore, the MSC 719 is connected to a Short Message Service Center (SMSC) 729 that stores and forwards short messages to and from the radio network 700.

During typical operation of the cellular telephone system, BTSs 705 receive and demodulate sets of reverse-link signals from sets of mobile units 701 conducting telephone calls or other communications. Each reverse-link signal received by a given BTS 705 is processed within that station. The resulting data is forwarded to the BSC 707. The BSC 707 provides call resource allocation and mobility management finctionality including the orchestration of soft handoffs between BTSs 705. The BSC 707 also routes the received data to the MSC 719, which in turn provides additional routing and/or switching for interface with the PSTN 721. The MSC 719 is also responsible for call setup, call termination, management of inter-MSC handover and supplementary services, and collecting, charging and accounting information. Similarly, the radio network 700 sends forward-link messages. The PSTN 721 interfaces with the MSC 719. The MSC 719 additionally interfaces with the BSC 707, which in turn communicates with the BTSs 705, which modulate and transmit sets of forward-link signals to the sets of mobile units 701.

As shown in FIG. 7B, the two key elements of the General Packet Radio Service (GPRS) infrastructure 750 are the Serving GPRS Supporting Node (SGSN) 732 and the Gateway GPRS Support Node (GGSN) 734. In addition, the GPRS infrastructure includes a Packet Control Unit PCU (1336) and a Charging Gateway Function (CGF) 738 linked to a Billing System 739. A GPRS the Mobile Station (MS) 741 employs a Subscriber Identity Module (SIM) 743.

The PCU 736 is a logical network element responsible for GPRS-related functions such as air interface access control, packet scheduling on the air interface, and packet assembly and re-assembly. Generally the PCU 736 is physically integrated with the BSC 745; however, it can be collocated with a BTS 747 or a SGSN 732. The SGSN 732 provides equivalent functions as the MSC 749 including mobility management, security, and access control functions but in the packet-switched domain. Furthermore, the SGSN 732 has connectivity with the PCU 736 through, for example, a Fame Relay-based interface using the BSS GPRS protocol (BSSGP). Although only one SGSN is shown, it is recognized that that multiple SGSNs 731 can be employed and can divide the service area into corresponding routing areas (RAs). A SGSN/SGSN interface allows packet tunneling from old SGSNs to new SGSNs when an RA update takes place during an ongoing Personal Development Planning (PDP) context. While a given SGSN may serve multiple BSCs 745, any given BSC 745 generally interfaces with one SGSN 732. Also, the SGSN 732 is optionally connected with the HLR 751 through an SS7-based interface using GPRS enhanced Mobile Application Part (MAP) or with the MSC 749 through an SS7-based interface using Signaling Connection Control Part (SCCP). The SGSN/HLR interface allows the SGSN 732 to provide location updates to the HLR 751 and to retrieve GPRS-related subscription information within the SGSN service area. The SGSN/MSC interface enables coordination between circuit-switched services and packet data services such as paging a subscriber for a voice call. Finally, the SGSN 732 interfaces with a SMSC 753 to enable short messaging fuinctionality over the network 750.

The GGSN 734 is the gateway to external packet data networks, such as the Internet 713 or other private customer networks 755. The network 755 comprises a Network Management System (NMS) 757 linked to one or more databases 759 accessed through a PDSN 761. The GGSN 734 assigns Internet Protocol (IP) addresses and can also authenticate users acting as a Remote Authentication Dial-In User Service host. Firewalls located at the GGSN 734 also perform a firewall function to restrict unauthorized traffic. Although only one GGSN 734 is shown, it is recognized that a given SGSN 732 may interface with one or more GGSNs 733 to allow user data to be tunneled between the two entities as well as to and from the network 750. When external data networks initialize sessions over the GPRS network 750, the GGSN 734 queries the HLR 751 for the SGSN 732 currently serving a MS 741.

The BTS 747 and BSC 745 manage the radio interface, including controlling which Mobile Station (MS) 741 has access to the radio channel at what time. These elements essentially relay messages between the MS 741 and SGSN 732. The SGSN 732 manages communications with an MS 741, sending and receiving data and keeping track of its location. The SGSN 732 also registers the MS 741, authenticates the MS 741, and encrypts data sent to the MS 741.

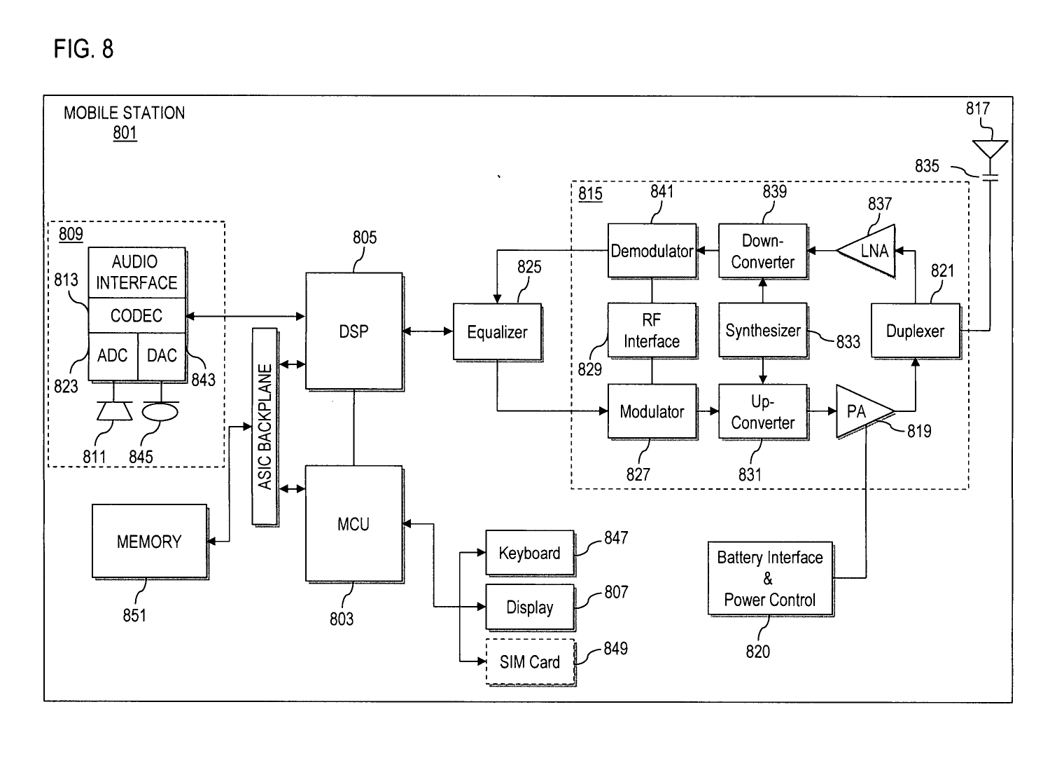

FIG. 8 is a diagram of exemplary components of a mobile station (e.g., handset) capable of operating in the systems of FIGS. 7A and 7B, according to an embodiment of the invention. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 803, a Digital Signal Processor (DSP) 805, and a receiver/transmitter unit including a microphone gain control unit and a speaker gain control unit. A main display unit 807 provides a display to the user in support of various applications and mobile station functions. An audio function circuitry 809 includes a microphone 811 and microphone amplifier that amplifies the speech signal output from the microphone 811. The amplified speech signal output from the microphone 811 is fed to a coder/decoder (CODEC) 813.

A radio section 815 amplifies power and converts frequency in order to communicate with a base station, which is included in a mobile communication system (e.g., systems of FIG. 7A or 7B), via antenna 817. The power amplifier (PA) 819 and the transmitter/modulation circuitry are operationally responsive to the MCU 803, with an output from the PA 819 coupled to the duplexer 821 or circulator or antenna switch, as known in the art. The PA 819 also couples to a battery interface and power control unit 820.

In use, a user of mobile station 801 speaks into the microphone 811 and his or her voice along with any detected background noise is converted into an analog voltage. The analog voltage is then converted into a digital signal through the Analog to Digital Converter (ADC) 823. The control unit 803 routes the digital signal into the DSP 805 for processing therein, such as speech encoding, channel encoding, encrypting, and interleaving. In the exemplary embodiment, the processed voice signals are encoded, by units not separately shown, using the cellular transmission protocol of Code Division Multiple Access (CDMA), as described in detail in the Telecommunication Industry Association's TIA/EIA/IS-95-A Mobile Station-Base Station Compatibility Standard for Dual-Mode Wideband Spread Spectrum Cellular System; which is incorporated herein by reference in its entirety.

The encoded signals are then routed to an equalizer 825 for compensation of any frequency-dependent impairments that occur during transmission though the air such as phase and amplitude distortion. After equalizing the bit stream, the modulator 827 combines the signal with a RF signal generated in the RF interface 829. The modulator 827 generates a sine wave by way of frequency or phase modulation. In order to prepare the signal for transmission, an up-converter 831 combines the sine wave output from the modulator 827 with another sine wave generated by a synthesizer 833 to achieve the desired frequency of transmission. The signal is then sent through a PA 819 to increase the signal to an appropriate power level. In practical systems, the PA 819 acts as a variable gain amplifier whose gain is controlled by the DSP 805 from information received from a network base station. The signal is then filtered within the duplexer 821 and optionally sent to an antenna coupler 835 to match impedances to provide maximum power transfer. Finally, the signal is transmitted via antenna 817 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 801 are received via antenna 817 and immediately amplified by a low noise amplifier (LNA) 837. A down-converter 839 lowers the carrier frequency while the demodulator 841 strips away the RF leaving only a digital bit stream. The signal then goes through the equalizer 825 and is processed by the DSP 1005. A Digital to Analog Converter (DAC) 843 converts the signal and the resulting output is transmitted to the user through the speaker 845, all under control of a Main Control Unit (MCU) 803—which can be implemented as a Central Processing Unit (CPU) (not shown).

The MCU 803 receives various signals including input signals from the keyboard 847. The MCU 803 delivers a display command and a switch command to the display 807 and to the speech output switching controller, respectively. Further, the MCU 803 exchanges information with the DSP 805 and can access an optionally incorporated SIM card 849 and a memory 851. In addition, the MCU 803 executes various control functions required of the station. The DSP 805 may, depending upon the implementation, perform any of a variety of conventional digital processing functions on the voice signals. Additionally, DSP 805 determines the background noise level of the local environment from the signals detected by microphone 811 and sets the gain of microphone 811 to a level selected to compensate for the natural tendency of the user of the mobile station 801.

The CODEC 813 includes the ADC 823 and DAC 843. The memory 851 stores various data including call incoming tone data and is capable of storing other data including music data received via, e.g., the global Internet. The software module could reside in RAM memory, flash memory, registers, or any other form of writable storage medium known in the art. The memory device 851 may be, but not limited to, a single memory, CD, DVD, ROM, RAM, EEPROM, optical storage, or any other non-volatile storage medium capable of storing digital data.

An optionally incorporated SIM card 849 carries, for instance, important information, such as the cellular phone number, the carrier supplying service, subscription details, and security information. The SIM card 849 serves primarily to identify the mobile station 801 on a radio network. The card 849 also contains a memory for storing a personal telephone number registry, text messages, and user specific mobile station settings.

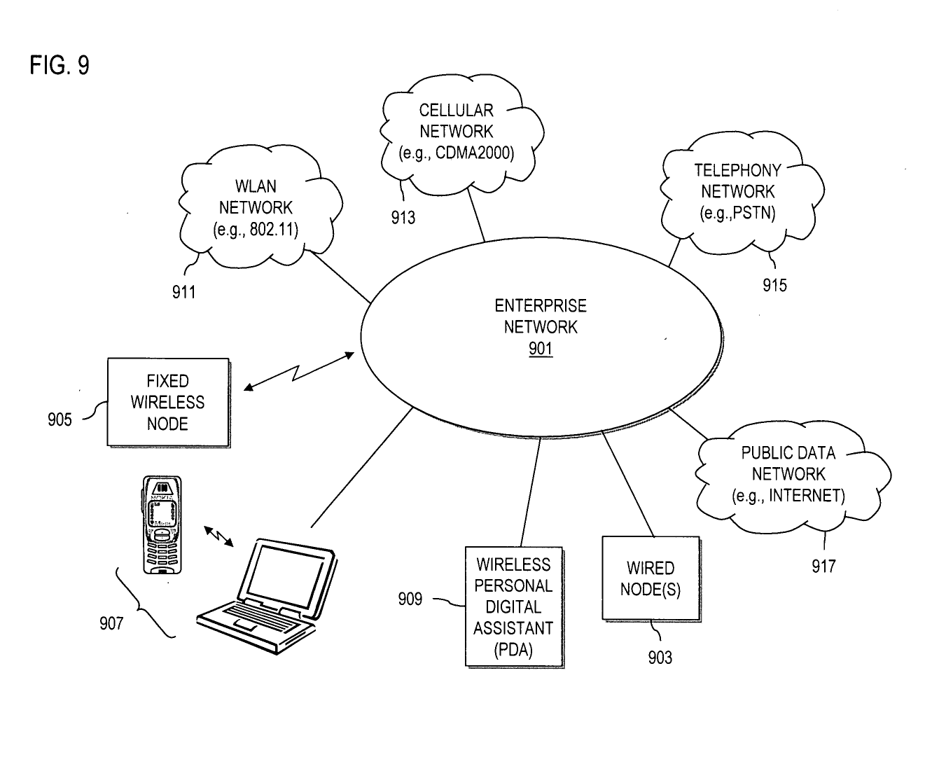

FIG. 9 shows an exemplary enterprise network, which can be any type of data communication network utilizing packet-based and/or cell-based technologies (e.g., Asynchronous Transfer Mode (ATM), Ethernet, IP-based, etc.). The enterprise network 901 provides connectivity for wired nodes 903 as well as wireless nodes 905-909 (fixed or mobile), which are each configured to perform the processes described above. The enterprise network 901 can communicate with a variety of other networks, such as a WLAN network 911 (e.g., IEEE 802.11), a cdma2000 cellular network 913, a telephony network 916 (e.g., PSTN), or a public data network 917 (e.g., Internet).

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving communication information that enables communication over a communication network; and
mapping the communication information to a sequence among a plurality of sequences having a predetermined correlation property to output a communication information sequence.

2. A method according to claim 1, wherein the communication information includes an address, the method further comprising:
assigning the communication information sequence to a terminal that is configured to communicate over the communication network using the communication information sequence.

3. A method according to claim 1, wherein the communication information includes a Medium Access Control (MAC) identifier, and the communication network includes a multi-carrier wireless network.

4. A method according to claim 1, wherein the sequence includes a Pseudo-Noise (PN) sequence.

5. A method according to claim 4, wherein the PN sequence is generated by generator polynomial, p(x)=x¹⁵+x¹³+x⁹+x⁸+x⁷+x⁵+1.

6. A method according to claim 1, further comprising:
determining an offset of the communication information sequence; and
mapping the offset to the communication information sequence.

7. A method according to claim 6, wherein the mapping of the offset is one-to-one, one-to- many, many-to-one, many-to-many, or a combination thereof.

8. A method according to claim 6, wherein the offset is determined based on the communication information, time, communication session and connection configuration information, communication service, or Quality of Service (QoS) parameter.

9. A method according to claim 1, further comprising:
modifying the offset based on time or in response to signaling message.

10. A method according to claim 1, wherein the communication information specifies transmission formation information that includes either data rate, encoder packet size, automatic repeat request channel identifier, or sub-packet identifier.

11. A method according to claim 1, further comprising:
negating one or more of the sequences to increase randomization of the sequences.

12. A method according to claim 1, wherein the communication information sequence is of variable length.

13. A method according to claim 1, further comprising:
scrambling control information using the communication information sequence.

14. An apparatus comprising:
circuitry configured to receive communication information that enables communication over a communication network,
wherein the circuitry is further configured to map the communication information to a sequence among a plurality of sequences having a predetermined correlation property to output a communication information sequence.

15. An apparatus according to claim 14, wherein the communication information includes an address, and the communication information sequence is assigned to a terminal that is configured to communicate over the communication network using the communication information sequence.

16. An apparatus according to claim 14, wherein the communication information includes a Medium Access Control (MAC) identifier, and the communication network includes a multi-carrier wireless network.

17. An apparatus according to claim 14, wherein the sequence includes a Pseudo-Noise (PN) sequence.

18. An apparatus according to claim 17, further comprising:
a PN generator configured to output the PN sequence using generator polynomial, p(x)=x¹⁵+x¹³+x⁹+x⁸+x⁷+X⁵+1.

19. An apparatus according to claim 14, wherein the circuitry is further configured to determine an offset of the communication information sequence, and to map the offset to the communication information sequence.

20. An apparatus according to claim 19, wherein the mapping of the offset is one-to-one, one-to-many, many-to-one, many-to-many, or a combination thereof.

21. An apparatus according to claim 19, wherein the offset is determined based on the communication information, time, communication session and connection configuration information, communication service, or Quality of Service (QoS) parameter.

22. An apparatus according to claim 14, wherein the offset is modified based on time or in response to signaling message.

23. An apparatus according to claim 14, wherein the communication information specifies transmission formation information that includes either data rate, encoder packet size, automatic repeat request channel identifier, or sub-packet identifier.

24. An apparatus according to claim 14, wherein one or more of the sequences is negated to increase randomization of the sequences.

25. An apparatus according to claim 14, wherein the communication information sequence is of variable length.

26. An apparatus according to claim 14, wherein the circuitry is further configured to scramble control information using the communication information sequence.

27. A system comprising the apparatus of claim 14.

28. A method comprising:
receiving, from a base station, communication information that enables communication over a communication network, wherein the communication information is mapped to a sequence among a plurality of sequences having a predetermined correlation property to output a communication information sequence; and
transmitting a message to the base station using the communication information sequence.

29. An apparatus according to claim 28, wherein the communication information includes a Medium Access Control (MAC) identifier, and the communication network includes a multi-carrier wireless network.

30. An apparatus comprising:
a transceiver configured to receive, from a base station, communication information that enables communication over a communication network; and
a processor configured to map the communication information to a sequence among a plurality of sequences having a predetermined correlation property to output a communication information sequence,
wherein the transceiver is further configured to transmit a message to the base station using the communication information sequence.

31. An apparatus according to claim 30, wherein the communication information includes a Medium Access Control (MAC) identifier, and the communication network includes a multi-carrier wireless network.

32. An apparatus according to claim 30, further comprising:
means for receiving user input to initiate communication over the communication network; and
a display configured to display the user input.
